(19) United States
(12) Patent Application Publication
(10) Pub. No.: US 2016/0224948 A1
(43) Pub. Date: Aug. 4, 2016

(54) MAINTENANCE MANAGEMENT DEVICE AND MAINTENANCE MANAGEMENT METHOD

(71) Applicant: KYOCERA Document Solutions Inc., Osaka (JP)

(72) Inventor: Yosuke MORISHITA, Osaka (JP)

(73) Assignee: KYOCERA Document Solutions Inc., Osaka (JP)

(21) Appl. No.: 15/006,823

(22) Filed: Jan. 26, 2016

(30) Foreign Application Priority Data
Jan. 30, 2015 (JP) 2015-016516
Jan. 30, 2015 (JP) 2015-016517

(51) Int. Cl. G06Q 10/00

(52) U.S. Cl. CPC G06Q 10/20

(57) ABSTRACT

A maintenance management device includes: an operation history section and an optimum operation extraction section. The operation history section, upon execution of a plurality of maintenance adjustment operations by a service man, leaves the plurality of maintenance adjustment operations as a history for the purpose of resolving a specific error. The optimum operation extraction section, based on the history, extracts, as an optimum maintenance adjustment operation, a common maintenance adjustment operation executed for the specific error in common by the plurality of service men.

### INCORPORATION BY REFERENCE

This application claims priority to Japanese Patent Application No. 2015-016516 filed on Jan. 30, 2015, and Japanese Patent Application No. 2015-016517 filed on Jan. 30, 2015, the entire contents of which are incorporated by reference herein.

### BACKGROUND

This disclosure relates to a maintenance management device and a maintenance management method.

An electronic device such as an image processor, in view of quality control of provided functions, requires execution of regular maintenance. Conventionally, there are a plurality of technologies related to this maintenance. For example, there is an image processor which determines whether or not a maintenance operation for recovering a state of a head at time of printing is required, upon determination that the maintenance operation is required, acquires time which has passed since the determination, and notifies the user of the acquired passage of time. Also known is a printer maintenance system which evaluates a printer from various aspects and notifies a user that maintenance is necessary.

### SUMMARY

As one aspect of this disclosure, a technology obtained by further improving the technology described above will be suggested.

A maintenance management device according to one aspect of this disclosure includes: an operation history section and an optimum operation extraction section.

The operation history section, upon execution of a plurality of maintenance adjustment operations by a service man, leaves the plurality of maintenance adjustment operations as a history for the purpose of resolving a specific error.

The optimum operation extraction section, based on the history, extracts, as an optimum maintenance adjustment operation, a common maintenance adjustment operation executed for the specific error in common by the plurality of service men.

A maintenance management method according to one aspect of this disclosure includes: an operation history step of, upon execution of a plurality of maintenance adjustment operations by a service man, leaving the plurality of maintenance adjustment operations as a history for the purpose of resolving a specific error; and an optimum operation extraction step of, based on the history, extracting, as an optimum maintenance adjustment operation, the common maintenance adjustment operation executed for the specific error in common by a plurality of service men.

### BRIEF DESCRIPTION OF THE DRAWINGS

FIG. 1 is a conceptual diagram showing overall configuration of an image processor provided with a maintenance management section according to an embodiment of this disclosure;

FIG. 2 is a functional block diagram of the image processor and the maintenance management section according to the embodiment of this disclosure;

FIG. 3 is a flowchart illustrating execution procedures according to the embodiment of this disclosure;

FIG. 4A is a diagram showing one example of a service man call screen according to the embodiment of this disclosure;

FIG. 4B is a diagram showing one example of a maintenance adjustment operation table according to the embodiment of this disclosure;

FIG. 5A is a diagram showing one example of a maintenance screen according to the embodiment of this disclosure;

FIG. 5B is a diagram showing one example of an operation history table according to the embodiment of this disclosure;

FIG. 6A is a diagram showing one example of the operation history table according to the embodiment of this disclosure;

FIG. 6B is a diagram showing one example of a user maintenance screen according to the embodiment of this disclosure;

FIG. 7A is a diagram showing one example of the operation history table according to the embodiment of this disclosure;

FIG. 7B is a diagram showing one example of a manager maintenance screen according to the embodiment of this disclosure;

FIG. 8A is a diagram showing one example of the operation history table according to the embodiment of this disclosure;

FIG. 8B is a diagram showing one example of an all user maintenance screen according to the embodiment of this disclosure;

FIG. 9 is a functional block diagram of an image processor and a maintenance management section according to another embodiment of this disclosure;

FIG. 10 is a flowchart showing execution procedures according to another embodiment of this disclosure;

FIG. 11A is a diagram showing one example of a service man call screen according to another embodiment of this disclosure;

FIG. 11B is a diagram showing one example of a maintenance adjustment operation table according to another embodiment of this disclosure;

FIG. 12A is a diagram showing one example of a maintenance screen according to another embodiment of this disclosure;

FIG. 12B is a diagram showing one example of an operation history table according to another embodiment of this disclosure;

FIG. 13A is a diagram showing one example of the operation history table according to another embodiment of this disclosure;

FIG. 13B is a diagram showing one example of a maintenance screen provided with optimum maintenance adjustment operations according to another embodiment of this disclosure;

FIG. 14A is a diagram showing one example of the operation history table according to another embodiment of this disclosure; and

FIG. 14B is a diagram showing one example of the operation history table according to another embodiment of this disclosure.

### DETAILED DESCRIPTION

Hereinafter, with reference to the accompanying drawings, embodiments of a maintenance management device and a maintenance management method of this disclosure will be described for better understanding of this disclosure. Note that the embodiments below are each a detailed example of this disclosure and thus do not limit a technical range of this disclosure. An alphabet S marked in front of each number in flowcharts means a step.

Hereinafter, as one example of the embodiments of this disclosure, an image processor provided with a maintenance management device (maintenance management section) will be described. As the image processor, for example, a multifunction peripheral (MFP) combining facsimile, copy, scanner, and printer functions, a copier, or a printer can be adopted.

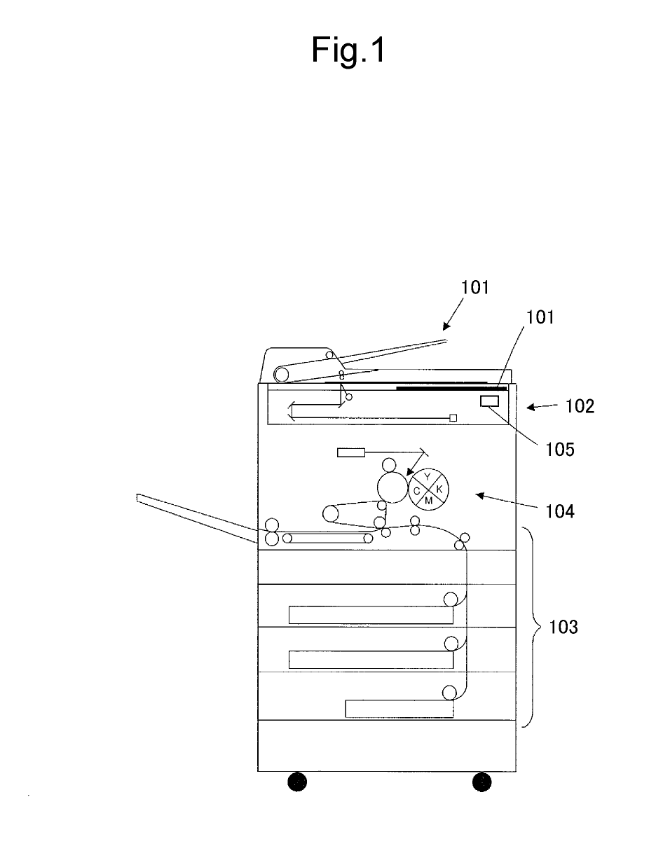

The image processor 100 receives, through an operation section 101, setting condition of a specific job from a user, as shown in FIG. 1. The job includes: for example, copying, facsimile, scanning, and printing.

The image processor 100, upon the reception of the setting condition of the job described above, drives each of an image reading section 102, a paper conveyance section 103, an image formation section 104, etc., to execute this job. The image reading section 102 reads image data of a document loaded on a document stand or an automatic document feed section. The paper conveyance section 103 conveys paper from a paper feed cassette or a manual feed tray to the image formation section 104. The image formation section 104 transfers, onto the conveyed paper, a toner image corresponding to the image data and fixes it with a fixing roller to execute image formation.

The image processor 100 has a maintenance management section 105 built therein, and the maintenance management section 105 displays a service man call screen at the operation section 101 upon occurrence of a specific error (for example, blurred printing) in the image processor 100. Upon display of a maintenance screen through the operation section 101 by a service man, the maintenance management section 105 displays a plurality of maintenance adjustment operations for resolving the error described above, urging the service man to sequentially execute the maintenance adjustment operations. The maintenance management section 105 records the maintenance adjustment operations executed by the service man, and extracts the optimum maintenance adjustment operation capable of resolving the specific error. Upon reoccurrence of the specific error, the maintenance management section 105 displays an execute key for executing processing corresponding to the optimum maintenance adjustment operation described above, and upon selection of this execute key by the user, the maintenance management section 105 executes the specific processing described above to thereby resolve the specific error.

Note that control circuits of the image processor 100 and the maintenance management section 105 connect together, with an internal bus, a central processing unit (CPU), a read only memory (ROM), a random access memory (RAM), a hard disc drive (HDD), a solid state drive (SSD), and drivers corresponding to respective driving sections, all not shown.

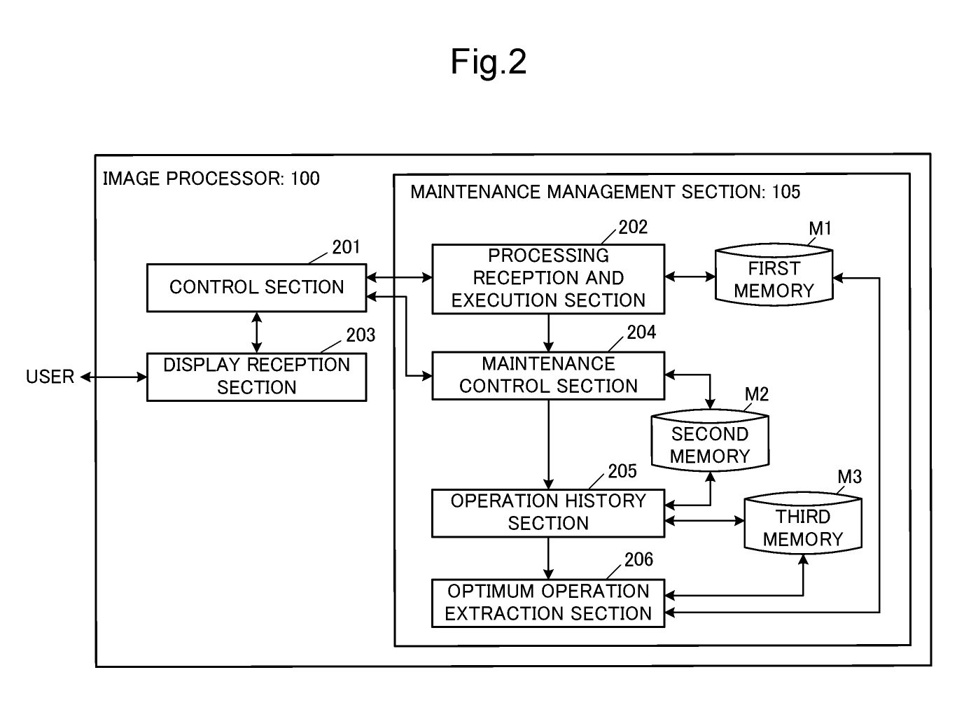

The CPU of the image processor 100 and the maintenance management section 105 uses, for example, the RAM as a working area, executes a program stored in, for example, the ROM, the HDD, or the SSD, receives data, instructions, signals, commands, etc. from the driver based on results of the aforementioned execution, and controls an operation of each driving section related to the job execution. Moreover, for various sections (shown in FIG. 2), to be described below, other than the driving sections, the CPU executes each program to thereby realize each of the various sections. Stored in the ROM, the RAM, the HDD, the SSD, etc. are a program and data for realizing the various sections described below.

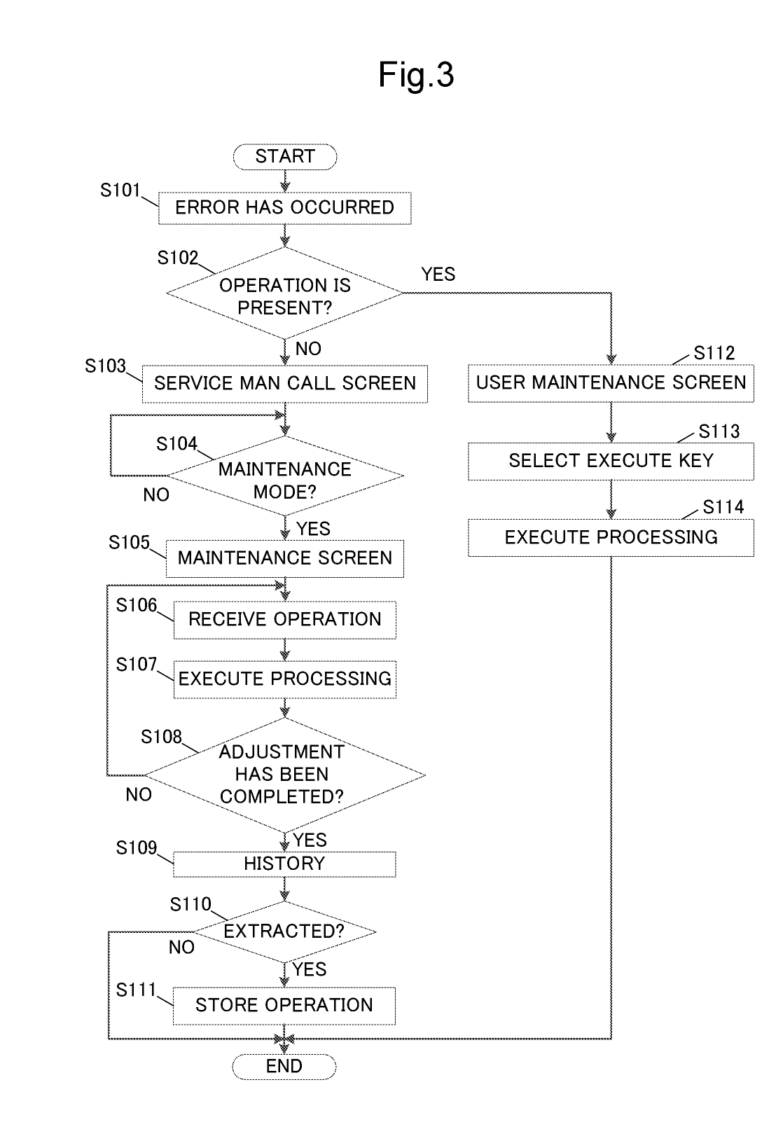

Next, with reference to FIGS. 2 and 3, configuration and execution procedures according to the embodiment of this disclosure will be described. First, upon occurrence of a specific error (for example, blurred printing) for some reason during use of the image processor 100 after user authentication through the operation section 101 of the image processor 100 (S101 of FIG. 3), a sensor inside of the image processor 100 detects the specific error described above, interrupts an operation in use by a control section 201 of the image processor 100, and notifies this to a processing reception and execution section 202 of the maintenance management section 105. The processing reception and execution section 202 which has received this notice, with reference to a first memory M1, determines whether or not any optimum maintenance adjustment operation capable of resolving the specific error is present (S102 of FIG. 3).

At this point, the optimum maintenance adjustment operation is not stored, and thus as a result of the aforementioned determination, the processing reception and execution section 202 determines that no optimum maintenance adjustment operation is present (NO in S102 of FIG. 3), and notifies this to a display reception section 203 via the control section 201 of the image processor 100. The display reception section 203 which has received this notice displays a service man call screen 400 on a touch panel of the operation section 101 (S103 of FIG. 3).

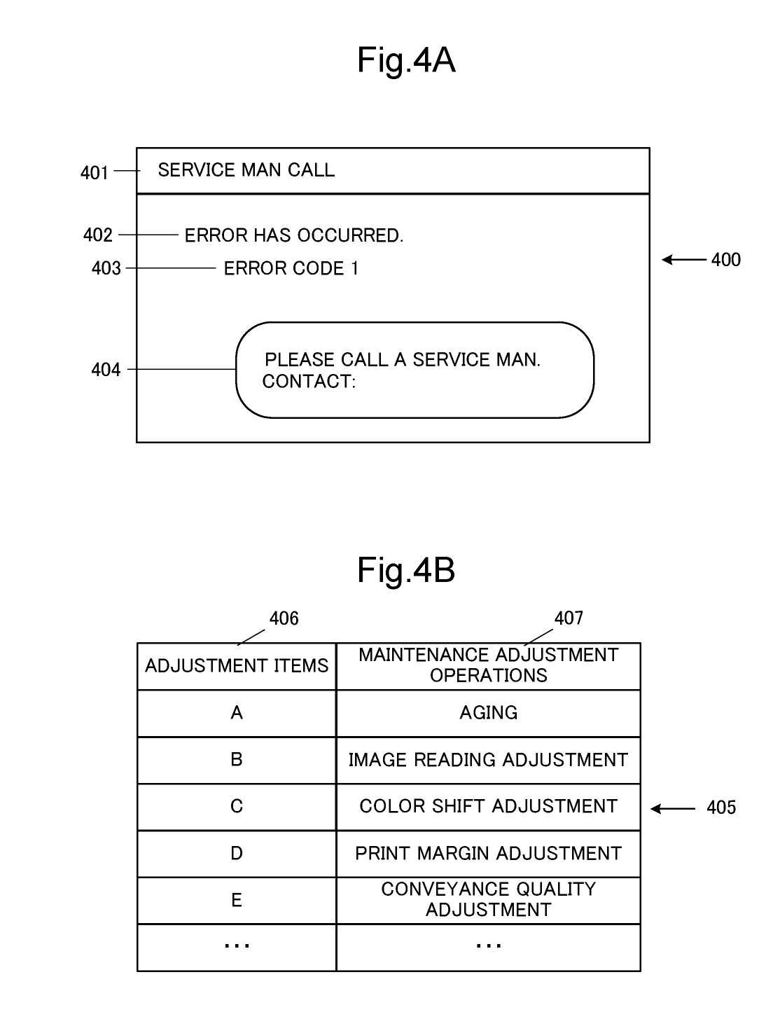

Displayed on the service man call screen 400 are: as shown in FIG. 4A, a message 401 indicating the service man call screen; a message 402 indicating that an error has occurred; an error code 403 corresponding to the occurring specific error; and a message 404 urging a user to make contact with a service man.

While viewing the service man call screen, the user makes contact with a specific service man (for example, a service man A) and makes him/her come over, and requests this service man A for resolving the specific error. After the user authentication in the image processor 100, the service man A operates a specific portion of the image processor 100 or the operation section 101 or performs a specific operation through the operation section 101 to thereby input, into the control section 201 of the image processor 100, a specific instruction for shifting to a maintenance mode. Only a service man is permitted to input the specific instruction.

The control section 201 which has received the instruction notifies this to a maintenance control section 204 of the maintenance management section 105, and the maintenance control section 204 which has received this notice shifts from a normal mode to the maintenance mode (YES in S104 of FIG. 3), and refers to a maintenance adjustment operation table 405 stored in a second memory M2.

On the maintenance adjustment operation table 405, as shown in FIG. 4B, adjustment items 406 (for example, “A”) for identifying respective maintenance adjustment operations and maintenance adjustment operation 407 (for example, “aging”) respectively corresponding to the adjustment items 406 are stored in association with each other.

Here, the maintenance adjustment operation 407 means an operation executed by the service man for resolving the specific error, and as a result of directing this operation to the maintenance management section 105 by the service man, processing corresponding to this operation is executed.

For example, the “aging” means processing of driving an engine (motor) of, for example, a photoconductor or a developing roller of the image formation section 104 for a specific period of time, and “image reading adjustment” means processing of executing document image data reading processing by the image reading section 102 and determining whether or not image reading can be done properly based on results of this processing. Moreover, “color shift adjustment” means processing of performing image formation on a full-color specific test pattern by the image formation section 104 and determining whether or not shift is occurring on each color of the test pattern, “print margin adjustment” means processing of changing, to a predetermined initial value, a size of a blank region located around a print region where the image formation (printing) is performed by the image formation section 104, and “conveyance quality adjustment” means processing of conveying paper by the paper conveyance section 103 and determining whether or not a paper jam occurs during the paper conveyance. An additional plurality of maintenance adjustment operations 407 are present. The maintenance adjustment operations 407 according to the embodiment of this disclosure mean processing executable by the image processor 100 and does not mean processing (for example, set value adjustment) performed thorough manual operation by the service man.

The maintenance control section 204 which has referred to the maintenance adjustment operation table 405 acquires the maintenance adjustment operations 407, and by using the maintenance adjustment operations 407, displays a maintenance screen 500 on the touch panel of the operation section 101 (S105 of FIG. 3).

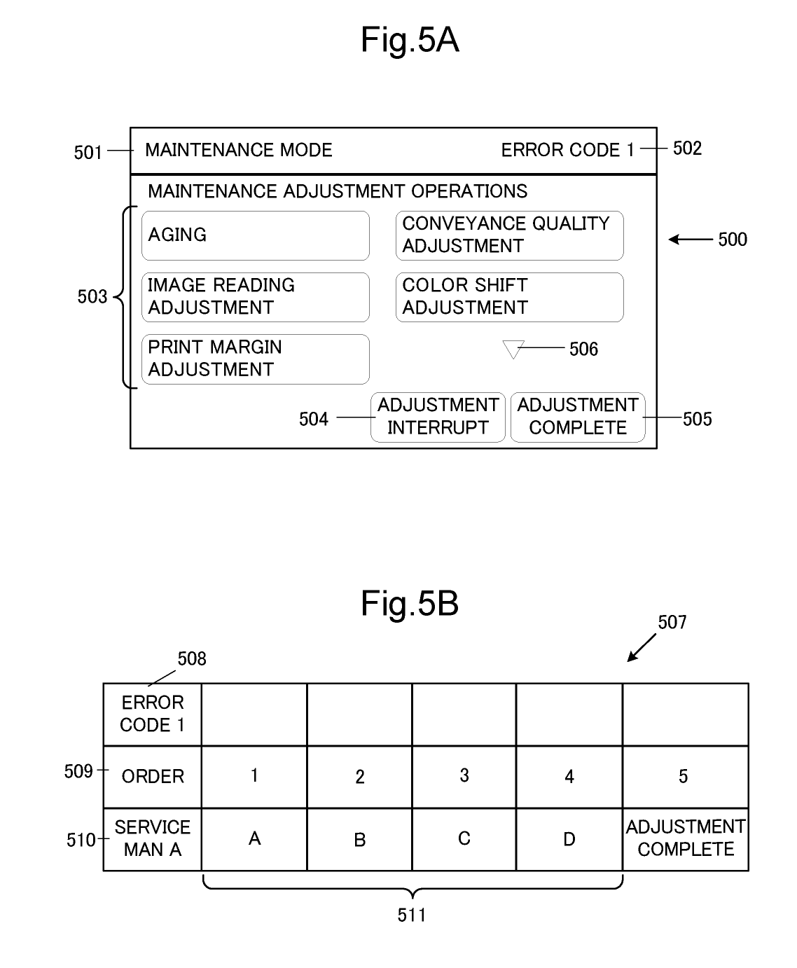

Displayed on the maintenance screen 500 are: as shown in FIG. 5A, a message 501 indicating the maintenance screen; the occurring specific error 502 (“error code 1”); maintenance adjustment operation keys 503 corresponding to the maintenance adjustment operations 407; an adjustment interrupt key 504 for interrupting the adjustment; and an adjustment complete key 505 for completing the adjustment. Also displayed near the maintenance adjustment operation keys 503 is a switch key 506 for separately displaying a maintenance adjustment operation key which cannot be displayed on the maintenance screen 500.

To resolve the specific error 502, while viewing the maintenance screen 500, the service man A selects the maintenance adjustment operation key 503, whereby the maintenance control section 204 receives a maintenance adjustment operation 408 of this maintenance adjustment operation key 503 (S106 of FIG. 3) and makes the image processor 100 execute the processing corresponding to this maintenance adjustment operation 408 (S107 of FIG. 3).

For example, upon selection of the “aging” key included in the maintenance adjustment operation keys 503 by the service man A, the maintenance control section 204 receives this “aging” key as the maintenance adjustment operation (S106 of FIG. 3) and makes the control section 201 execute the processing corresponding to this “aging” (S107 of FIG. 3).

Here, in a case where the specific error cannot be resolved even by executing the processing described above, the service man A selects another maintenance adjustment operation key 503 (S106 of FIG. 3) without selecting the adjustment complete key 505 (NO in S108 of FIG. 3) and makes the image processor 100 execute the processing corresponding to this key 503 (S107 of FIG. 3).

As described above, the service man A can repeatedly perform the various maintenance adjustment operations in a trial-and-error manner to thereby resolve the specific error. Here, for example, assume that the service man A selects the “aging” key, the “image reading adjustment” key, the “color shift adjustment” key, and the “print margin adjustment” key in an order just mentioned, and the maintenance control section 204 sequentially executes the processing corresponding to the respective keys.

Then the specific error is resolved, the sensor inside of the image processor 100 no longer detects this specific error, and the control section 201 of the image processor 100 notifies this to the maintenance control section 204. The maintenance control section 204 which has received this notice, for example, lights up the adjustment complete key 505 of the maintenance screen 500 to notify this adjustment completion to the service man A. Upon selection of the adjustment complete key 505 by the service man A (YES in S108 of FIG. 3), the maintenance adjustment operation for the specific error completes.

Here, upon the completion of the maintenance adjustment operations, the maintenance control section 204 notifies this to an operation history section 205, and the operation history section 205 which has received this notice leaves, as a history, the plurality of maintenance adjustment operations executed by the service man for resolving the specific error (S109 of FIG. 3).

For example, the operation history section 205 acquires the plurality of maintenance adjustment operations (for example, the “aging” and the “image reading adjustment”), which have been executed for the specific error (the “error code 1”) by the service man A, in an order in which they have been executed (for example, “1” and “2”). Next, the operation history section 205, with reference to the maintenance adjustment operation table 405, acquires the adjustment items (for example, “A”) corresponding to the acquired plurality of maintenance adjustment operations (for example, “the aging”) in the order just mentioned. Then the operation history section 205, with reference to a predetermined operation history table 507 previously stored in a third memory M3, stores the specific error, the adjustment items, and the order into this operation history table 507 in association with each other.

On the operation history table 507, as shown in FIG. 5B, an error code 508 (“error code 1”) corresponding to the specific error, an order 509 (“1”, “2”, etc.) in which the maintenance adjustment operations have been executed, identification information 510 (“service man A”) of the service man who has executed the maintenance adjustment operations, and adjustment items 511 (for example, “A”, “B”, etc.) corresponding to the order 509 are stored in association with each other. In a case where, of the adjustment items 511, the maintenance adjustment operations have finally completed, “adjustment complete” indicating this is stored in the last order (“5”). As a result, the maintenance adjustment operations actually performed by each service man can be left as a history.

Upon completion of the aforementioned storage by the operation history section 205, this is notified to an optimum operation extraction section 206, and the optimum operation extraction section 206 which has received this notice, based on the operation history table 507, determines whether or not to extract the common maintenance adjustment operation executed in common by the plurality of service men for the specific error (S110 of FIG. 3).

Here, at this point, the operation history table 507 still has only the history of the maintenance adjustment operations performed by the single service man. In this case, there is low possibility that the specific error can be resolved through the aforementioned maintenance adjustment operations (lack of reliability). Thus, the optimum operation extraction section 206 determines not to extract the common maintenance adjustment operation (NO in S110 of FIG. 3), ending the processing.

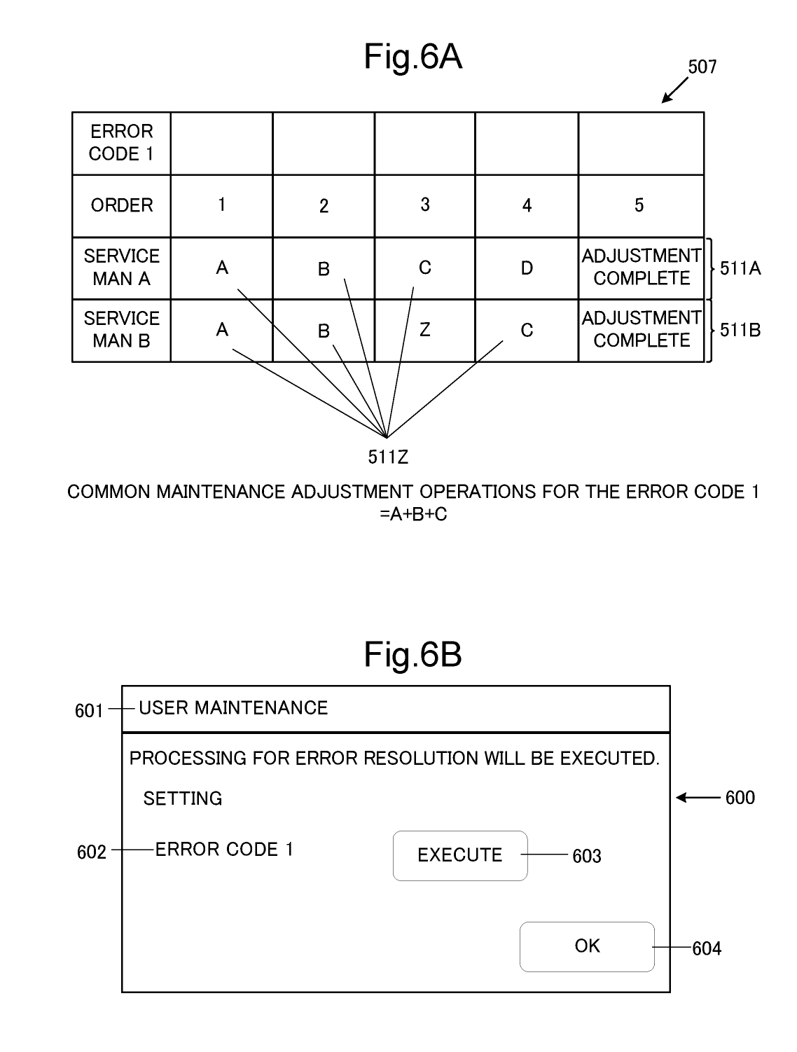

On the other hand, assume that the specific error occurs again, and this time the different service man (service man B) displays the maintenance screen 500 and executes the plurality of maintenance adjustment operations to thereby resolve the specific error and completes the maintenance adjustment operations. Then in S109, the operation history section 205 leaves, as a history, the plurality of maintenance adjustment operations executed by the service man B (S109 of FIG. 3), and as shown in FIG. 6A, on the operation history table 507, the plurality of maintenance adjustment operations executed by the two different service men are left as histories. In this case, there is high possibility that the specific error can be resolved with the common maintenance adjustment operations extracted from the maintenance adjustment operations. Then in S110, the optimum operation extraction section 206 determines to extract the common maintenance adjustment operations (YES in S110 of FIG. 3), executing the extraction processing.

More specifically, the optimum operation extraction section 206 compares a plurality of adjustment items 511A belonging to one (service man A) of the service men and a plurality of adjustment items 511B belonging to the other one (service man B) of the service men with each other on an individual adjustment item basis and extracts the common (identical) adjustment items 511Z (“A”, “B”, and “C”). As described above, the extraction of only the actually executed common maintenance adjustment operations can eliminate the operation assumed to be unnecessary and thereby shorten a period of time of the adjustment made by the user in the execution of the optimum maintenance adjustment operation. Moreover, permitting a general user to execute the maintenance adjustment operations may result in failure to perform a proper operation as a result of the execution of the unnecessary maintenance adjustment operation. Thus, limiting targets of extraction to the common maintenance adjustment operations can resolve the inconvenience described above.

Here, for the resolution of the specific error, an order of the individual maintenance adjustment operations is important in some cases. For example, in a case where the specific error is the “blurred printing”, as the optimum maintenance adjustment operations, the “aging” and then “the image reading adjustment” are executed, and then the “color shift adjustment” is executed, whereby the “blurred printing” may be effectively resolved.

Then the optimum operation extraction section 206 extracts the common maintenance adjustment operations, which have been executed in a common order by the plurality of service men, in the order just mentioned. For example, as shown in FIG. 6A, in a case where the order of the common adjustment items 511Z of one (service man A) of the service men is “A”, “B”, and “C” and the order of the common adjustment items 511Z of the other one (service man B) of the service men is “A”, “B”, and “C”, the order of the common adjustment items is also common. In this case, the optimum operation extraction section 206 extracts the common adjustment items 511Z “A”, “B”, and “C” in this order. As a result, the plurality of common maintenance adjustment operations which can reliably resolve the specific error can be extracted.

On the other hand, for example in a case where the order of the common adjustment items 511Z of one (service man A) of the service men is “A”, “B”, and “C” and the order of the common adjustment items 511Z of the other one (service man B) of the service men is “A”, “C”, and “B”, of the common adjustment items 511Z, the common adjustment item 511Z of which order is common is only “A”. In this case, the optimum operation extraction section 206 extracts the common adjustment item 511Z “A” in this order. In other words, the common adjustment items 511Z “B” and “C” are assumed to have no great contribution to the resolution of the specific error. As described above, the operation assumed to be unnecessary based on the order described above may be eliminated.

Upon completion of the extraction of the common maintenance adjustment operations (the common adjustment items 511Z) by the optimum operation extraction section 206, the common maintenance adjustment operations (common adjustment items 511Z) are stored as the optimum maintenance adjustment operations for the specific error into the first memory M1. In a case where there are a plurality of the common maintenance adjustment operations, the optimum operation extraction section 206 creates procedures (a flow) with which the plurality of common maintenance adjustment operations are arranged in the order described above, and stores them into the first memory M1. As a result, the optimum maintenance adjustment operations for the specific error can be provided.

Then next, during use of the image processor 100 by the user, the specific error occurs, and in S102, the processing reception and execution section 202, with reference to the first memory M1, determines that any optimum maintenance adjustment operation is present for the specific error (YES in S102 of FIG. 3). Then the processing reception and execution section 202, through the control section 201 and the display section 203, based on the optimum maintenance adjustment operation stored in the first memory M1, displays, on the touch panel of the operation section 101, a user maintenance screen 600 to which the user can refer (S112 of FIG. 3).

Displayed on the user maintenance screen 600 are: as shown in FIG. 6B, a message 601 indicating the user maintenance screen; the occurring specific error 602 (“error code 1”); an execute key 603 for executing the optimum maintenance adjustment operation; and an OK key 604.

Upon selection of the execute key 603 by the user while viewing the user maintenance screen 600, the processing reception and execution section 202 receives the selection of this execute key 603 (S113 of FIG. 3), and makes the image processor 100 execute the processing corresponding to the optimum maintenance adjustment operation (S114 of FIG. 3).

In the above, as the optimum maintenance adjustment operations, the common adjustment items 511Z “A”, “B”, and “C” are stored in this order, and thus the processing reception and execution section 202 executes the processing of the “aging”, the “image reading adjustment”, and the “color shift adjustment” in correspondence with the common adjustment items 511Z “A”, “B”, and “C”. As described above, providing the user with the right of executing the processing of the optimum maintenance adjustment operations which are included in the maintenance adjustment operations executed in the past by the service man and which may resolve the specific error makes it possible for even a general user to execute the processing of the maintenance adjustment operations that could not be executed by the service man, which makes it possible to eliminate labor of calling a service man and the adjustment operations by the service man.

As described above, the right of execution provided to the user is only the selection of the execute key 603, and execution of the maintenance adjustment operation involving an manual operation is not permitted, and thus there is low possibility that the user comes to know details of the maintenance adjustment operations, which ensures confidentiality of this maintenance adjustment operation.

It is assumed that the specific error is resolved by the processing of the optimum maintenance adjustment operations, and if the specific error is not resolved, the user calls a service man, and the service man attempts to resolve the specific error through the maintenance screen 500.

In this disclosure, the larger the number of service men who have executed the maintenance adjustment operations for a specific error is, the more the common maintenance adjustment operations are limited, which permits efficient extraction of the optimum maintenance adjustment operations. Thus, changing a kind of the user capable of execution in accordance with the number of operations forming the optimum maintenance adjustment operations may provide all the users with the right of executing the optimum maintenance adjustment operations reliably contributing to error resolution and may provide only authorized managers with the right of executing the optimum maintenance adjustment operations for which the error resolution is not reliable (lack of reliability).

For example, in a case where the number of operations forming the optimum maintenance adjustment operations exceeds a predetermined threshold value (for example, two third of the number of optimum maintenance adjustment operations stored at a first place), the processing reception and execution section 202 receives execution of the processing corresponding to the optimum maintenance adjustment operations for which only managers from among the users are provided with the right of execution. On the other hand, in a case where the number of service men who have executed the maintenance adjustment operations increases and the number of operations forming the optimum maintenance adjustment operations is equal to or smaller than the threshold value, the processing reception and execution section 202 receives execution of the processing corresponding to the optimum maintenance adjustment operations by all the users including the managers.

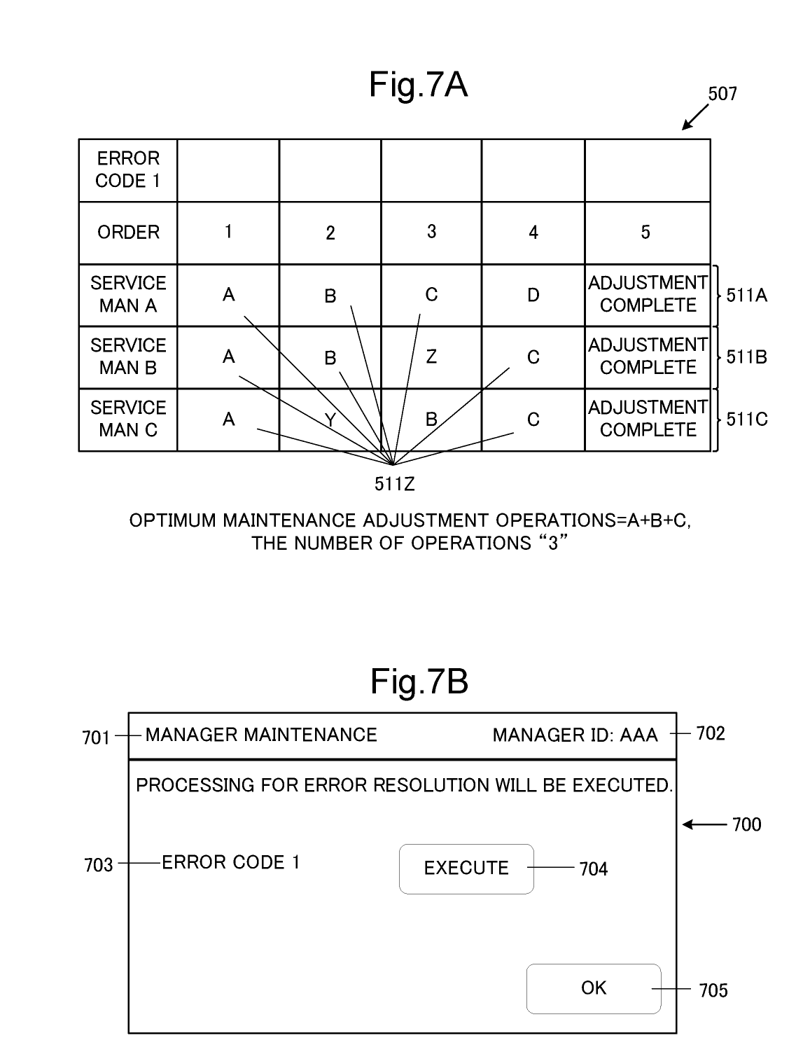

More specifically, as shown in FIG. 7A, in a case where the three service men have executed the maintenance adjustment operations on a specific error in the past, the optimum operation extraction section 206 compares, on the operation history table 507, a plurality of adjustment items 511A belonging to the first service man (service man A), a plurality of adjustment items 511B belonging to the second service man (service man B); and a plurality of adjustment items 511C belonging to the third service man (service man C) on an individual adjustment item basis to extract the common adjustment items 511Z (“A”, “B”, and “C”). In this case, the number of optimum maintenance adjustment operations corresponding to the common adjustment items 511Z is “3”, and the number of the first optimum maintenance adjustment operations executed by the two service men is also “3”, which are identical. Thus, in S102, although the optimum maintenance adjustment operations are present, the processing reception and execution section 202 determines that the number “3” of operations forming the optimum maintenance adjustment operations exceeds the threshold value (the number of the first operations “3”×⅔=2). Then while the specific error is occurring, the processing reception and execution section 202 determines whether or not a login user for which user authentication is performed in the image processor 100 is a manager, and if this login user is the manager (user with a manager ID “AAA”), it displays, on the touch panel of the operation section 101, a manager maintenance screen 700 to which only the manager can refer (S112 of FIG. 3).

Displayed on the manager maintenance screen 700 are: as shown in FIG. 7B, a message 701 indicating the manager maintenance screen; a user ID 702 of the manager (a manager ID “AAA”); the occurring specific error 703 (“error code 1”); an execute key 704; and an OK key 705. As a result, it is possible to select the execute key 704 only by the manager, making it possible for only the manager to make the image processor 100 execute the processing of the optimum maintenance adjustment operations.

On the other hand, in a case where the login user is not a manager, that is, in a case where it is a general user, the processing reception and execution section 202, without receiving from this general user the execution of the processing corresponding to the optimum maintenance adjustment operations, notifies this to the display reception section 203, and the display reception section 203 displays the service man call screen 400 on the touch panel of the operation section 101 (S103 of FIG. 3). In this case, the general user calls a service man to resolve the specific error.

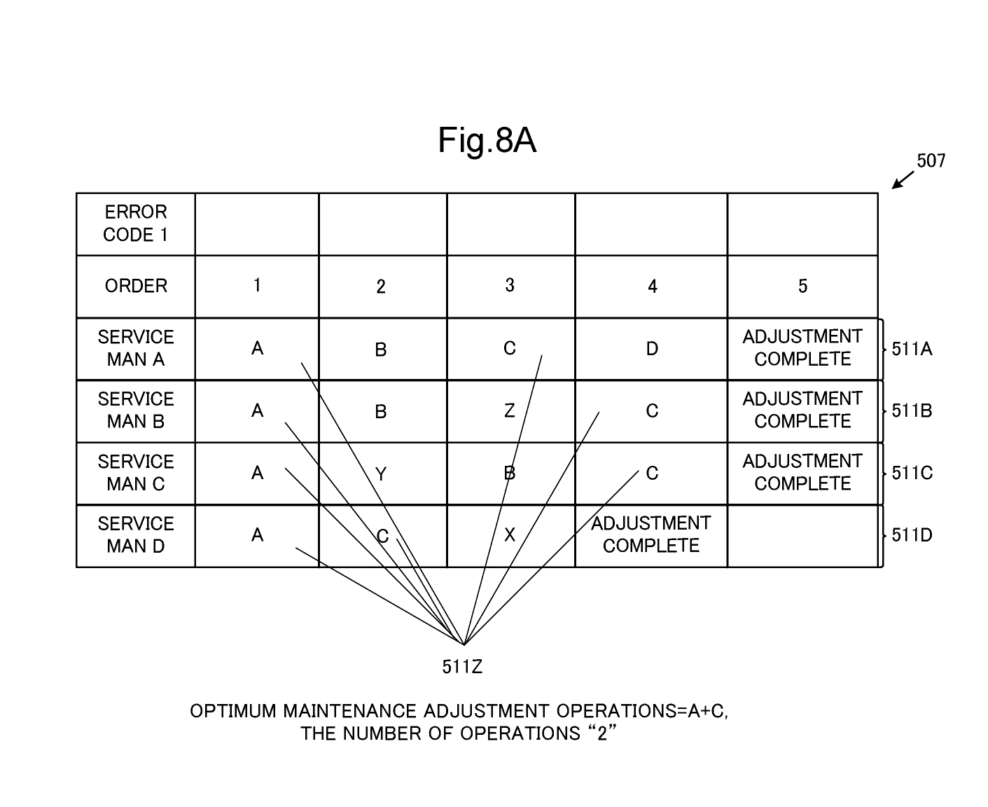

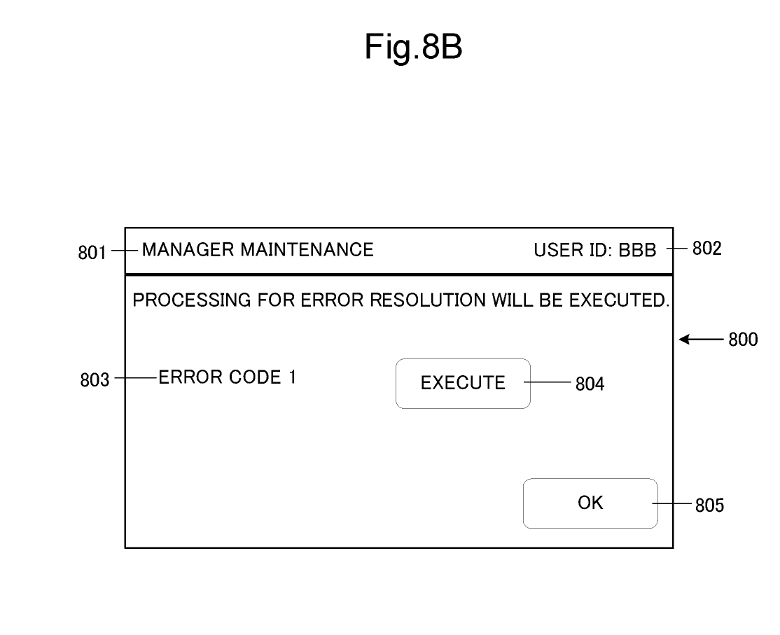

Then upon resolution of the specific error by a fourth service man, as shown in FIG. 8A, a history of the maintenance adjustment operations of the four service man is left. In this case, the optimum operation extraction section 206, on the operation history table 507, extracts the common adjustment items (“A” and “C”) based on the plurality of adjustment items 511A belonging to the first service man (service man A), the plurality of adjustment items 511B belonging to the second service man (service man B), the plurality of adjustment items 511C belonging to the third service man (service man C), and a plurality of adjustment items 511D belonging to the fourth service man (service man D), and the number of service men who have executed the maintenance adjustment operations consequently increases, and thus the number of optimum maintenance adjustment operations corresponding to the common adjustment items 511Z is “2”, which is smaller than the number “3” of the first optimum maintenance adjustment operations. Thus, in S102, the processing reception and execution section 202 determines that the number “2” of operations forming the optimum maintenance adjustment operations is equal to or less than the threshold value (the number of the first operations “3”×⅔=2). Then when the specific error is occurring, the processing reception and execution section 202 confirms that all the users including the managers have performed user authentication with the image processor 100, and then displays, on the touch panel of the operation section 101, an all user maintenance screen 800 to which all the users can refer (S112 of FIG. 3).

Displayed on the all user maintenance screen 800 are: as shown in FIG. 8B, a message 801 indicating a manager maintenance screen; a user ID 802 of the login user (user ID “BBB”); the occurring specific error 803 (“error code 1”); an execute key 804; and an OK key 805. As a result, upon determination that the optimum maintenance adjustment operations can resolve the specific error with high accuracy, all the users can make the image processor 100 execute the processing of the optimum maintenance adjustment operations through the execute key 804, making it possible to realize efficient error resolution.

In the embodiment of this disclosure, the optimum operation extraction section 206 puts its target on the completed maintenance adjustment operations completed by the service man when the specific error has been resolved, but different configuration may be provided. For example, the operation history section 205 may leave, as a history, the interrupted maintenance adjustment operations which have been interrupted by the service man when the specific error has not been resolved. Then permitted configuration is such that the optimum operation extraction section 206, based on the completed maintenance adjustment operations, extracts the common maintenance adjustment operations and extract, as the preferential common maintenance adjustment operations, the common maintenance adjustment operations which are included in the interrupted maintenance adjustment operations. For example, permitted configuration is such that the optimum operation extraction section 206 extracts, as the optimum common maintenance adjustment operations, only the common maintenance adjustment operations of the completed maintenance adjustment operations not included in the interrupted maintenance adjustment operations. As a result, the maintenance adjustment operations not related to the specific error resolution can efficiently be eliminated.

Moreover, in the embodiment of this disclosure, it is configured such that the optimum operation extraction section 206 extracts the common maintenance adjustment operations, which have been executed by the plurality of service men in a common order, in this order, but different configuration may be provided. As described above, for the specific error resolution, an order of the individual maintenance adjustment operations is important in some cases, but executing the common maintenance adjustment operations not in order resolves the specific error in some cases. In this case, the optimum operation extraction section 206 may extract all the common maintenance adjustment operations without considering the order, and the maintenance control section 204 may display all the common maintenance adjustment operations as the optimum maintenance adjustment operations.

Moreover, in the embodiment of this disclosure, it is configured such that, in a case where only a history of maintenance adjustment operations performed by the single service man is present on the operation history table 507, the optimum operation extraction section 206 does not extract the common maintenance adjustment operations, but different configuration may be provided. For example, even for the less reliable maintenance adjustment operation, the manager may be provided with the right of execution. Thus, for example, permitted configuration is such that the optimum operation extraction section 206 may extract, as the common maintenance adjustment operations, the plurality of maintenance adjustment operations executed by the single service man, and the processing reception and execution section 202 may receive, only from the manager, execution of the processing corresponding to the common maintenance adjustment operations executed by the single service man. As a result, the common maintenance adjustment operations can be open to the manager as much as possible.

Moreover, in the embodiment of this disclosure, it is configured such that, upon occurrence of the specific error, in a case where the optimum maintenance adjustment operation is present (YES in S102 of FIG. 3), the processing reception and execution section 202 receives the execution of the processing corresponding to the optimum maintenance adjustment operation through the user maintenance screen 600, but different configuration may be provided. For example, permitted configuration is such that, in a case where a user maintenance key prompting user maintenance is previously prepared on the service man call screen 400 or a normal operation screen and the user selects this user maintenance key, the processing reception and execution section 202 displays the user maintenance screen 600 again.

Typically, only service men can operate a maintenance-related software of an electronic device, and normal users cannot operate this software. Thus, in a case where a specific error occurs in, for example, this electronic device, the user calls a service man and requests this service man for resolving the specific error. As described above, preventing a general user from operating the software prevents operation stop of the electronic device as a result of operating the software.

However, in a case where the specific error frequently occurs, the only thing the user can do is calling a service man, thus bringing about a problem of much labor and time on both a user side and a service man side. Moreover, permitting the user to perform only operations capable of resolving the specific error to allow execution of an operation of the software by the user himself or herself no longer requires the labor and time for calling a service man.

According to the embodiment of this disclosure described above, such a problem can be resolved, and as described above, loads on a user and a service man for resolution of a specific error can be reduced.

Moreover, described in the embodiment of this disclosure is the image processor 100 provided with the maintenance management section 105, but this disclosure is also applicable to an electronic device which requires resolution of an error by a service man upon occurrence of the error.

The description of the embodiment above is based on the assumption that the image processor 100 includes the aforementioned various sections (at least the processing reception and execution section 202, the operation history section 205, and the optimum operation extraction section 206), but a program realizing the aforementioned various sections (at least the processing reception and execution section 202, the operation history section 205, and the optimum operation extraction section 206) of the image processor 100 may be stored in a recording medium such as the HDD or memory of the image processor 100, and the CPU of the image processor 100 may operate in accordance with this program and may thereby function as the aforementioned various sections (at least the processing reception and execution section 202, the operation history section 205, and the optimum operation extraction section 206).

Next, the program itself read from the recording medium provides effect as the embodiment of this disclosure.

Moreover, the procedures of processing by the image processor 100, which procedures have been shown in the embodiment above, are also recognized as a method of image processing performed by the image processor.

Next, an image processor provided with a maintenance management device (maintenance management section) according to another embodiment of this disclosure will be described. In the description of another embodiment, configuration common with that of the embodiment described above with reference to FIGS. 1 to 8B will be omitted, and unless otherwise specified, configuration of the image processor 1100 according to another embodiment is identical to that of the embodiment described above with reference to FIGS. 1 to 8B.

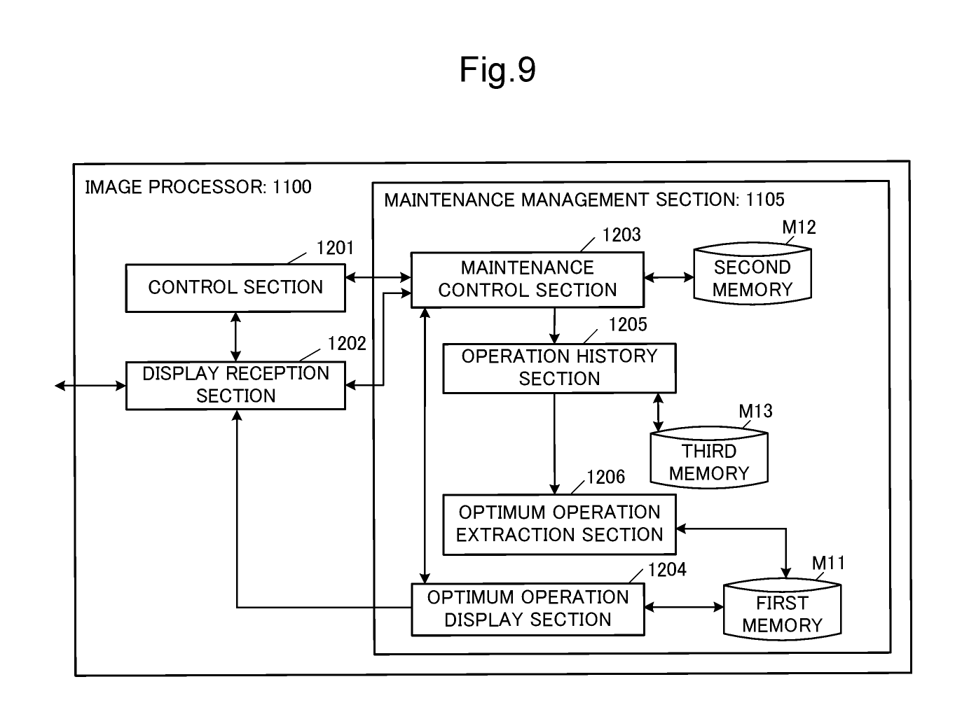

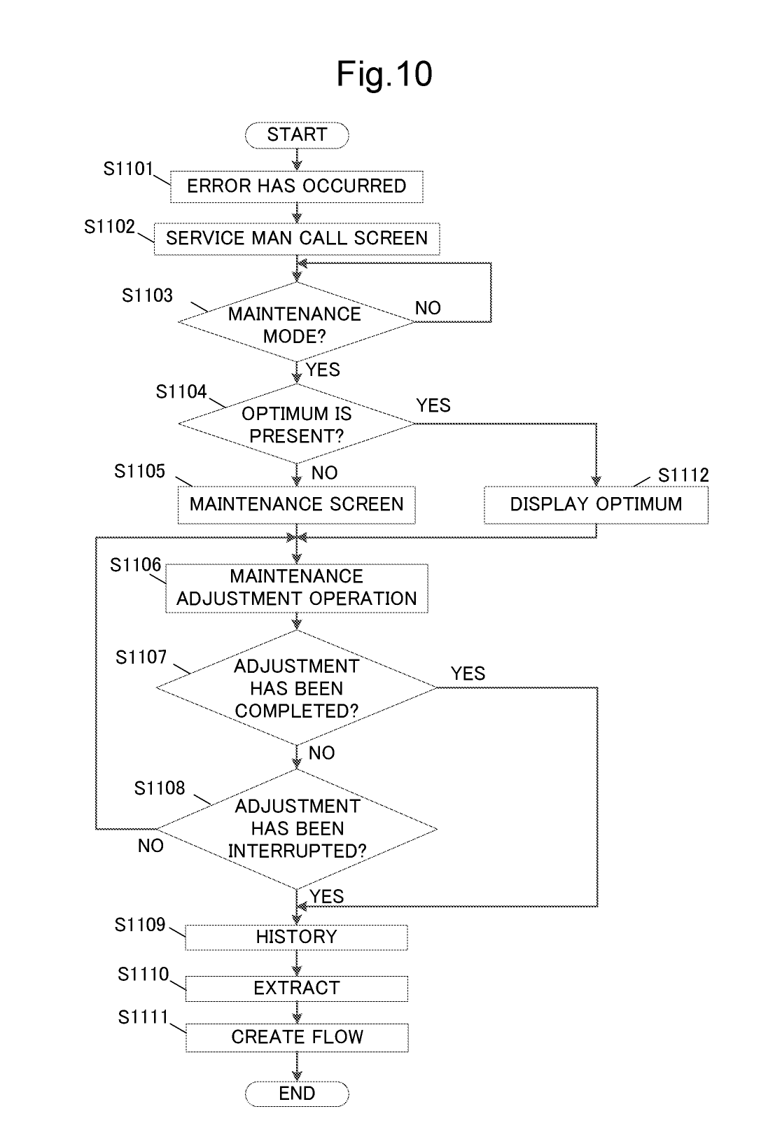

Next, referring to FIGS. 9 and 10, configuration and execution procedures according to another embodiment of this disclosure will be described. First, upon occurrence of a specific error (for example, blurred printing) for some reason during use of the image processor 1100 by a user (S1101 of FIG. 10), a sensor inside of the image processor 1100 detects the specific error, and a control section 1201 of the image processor 1100 interrupts an operation in use and notifies this to a display reception section 1202. The display reception section 1202 which has received this notice displays a service man call screen 1400 on a touch panel of an operation section 1101 (S1102 of FIG. 10).

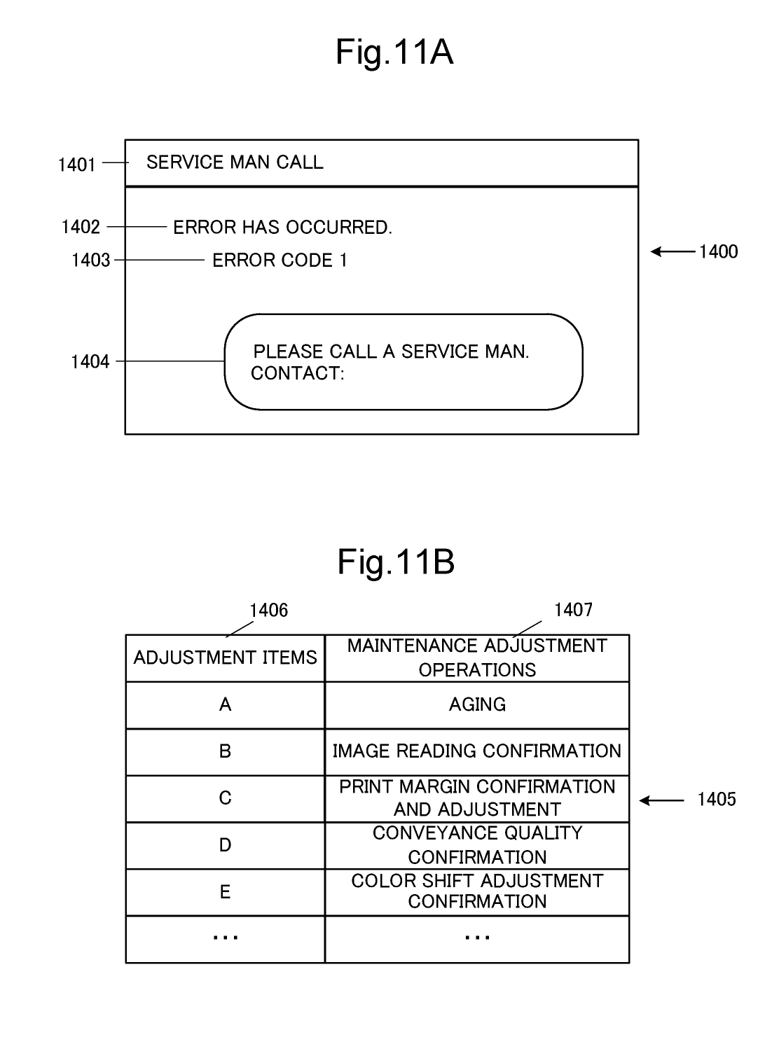

Displayed on the service man call screen 1400 are: as shown in FIG. 11A, a message 1401 indicating the service man call screen; a message 1402 indicating that the error has occurred; an error code 1403 corresponding to the occurring specific error; and a message 1404 urging the user to make contact with a service man.

While viewing the service man call screen 1400, the user makes contact with the specific service man (for example, the service man A), makes him or her come over, and requests this service man A for resolving the specific error. The service man A performs user authentication in the image processor 1100 and then operates a specific portion of the image processor 1100 or the operation section 1101 or performs a specific operation through the operation section 1101 to thereby input a specific instruction for shifting to a maintenance mode to the control section 1201 of the image processor 1100. The inputting of the specific instruction is permitted to only the aforementioned service man A or a manager.

The control section 1201 which has received the instruction notifies this to a maintenance control section 1203 of a maintenance management section 1105, and the maintenance control section 1203 which has received this notice shifts from a normal mode to a maintenance mode (YES in S1103 of FIG. 10) and notifies this to an optimum operation display section 1204. The optimum operation display section 1204 which has received this notice, with reference to a first memory M11, determines whether or not any optimum maintenance adjustment operation for the specific error is present (S1104 of FIG. 10).

At this point, the optimum maintenance adjustment operation is not stored, and thus as a result of the determination described above, the optimum operation display section 1204 determines that the optimum maintenance adjustment operation is not present (NO in S1104 of FIG. 10) and notifies this to the maintenance control section 1203. The maintenance control section 1203 which has received this notice refers to a maintenance adjustment operation table 1405 stored in a second memory M12.

On the maintenance adjustment operation table 1405, as shown in FIG. 11B, adjustment items 1406 (for example, “A”) for identifying maintenance adjustment operations and maintenance adjustment operations 1407 (for example, “aging”) respectively corresponding to the maintenance adjustment operation items 1406 are stored in association with each other.

For example, “image reading confirmation” means processing of scanning a document by an image reading section 1102 and determining whether or not the document can be properly scanned based on results of this scanning. Moreover, “print margin confirmation and adjustment” means processing of making the service man confirm a size of a blank region located around a print region where an image formation section 1104 performs image formation (printing) and adjust this size. The “aging”, “conveyance quality confirmation”, and “color shift adjustment confirmation” are identical to those in the embodiment described above with reference to FIGS. 1 to 7B. In addition, a plurality of maintenance adjustment operations 1408 are present.

The maintenance control section 1203 which has referred to the maintenance adjustment operation table 1405 acquires the maintenance adjustment operations 1407, and displays a maintenance screen 1500 on the touch panel of the operation section 1101 by using the maintenance adjustment operations 1407 (S1105 of FIG. 10).

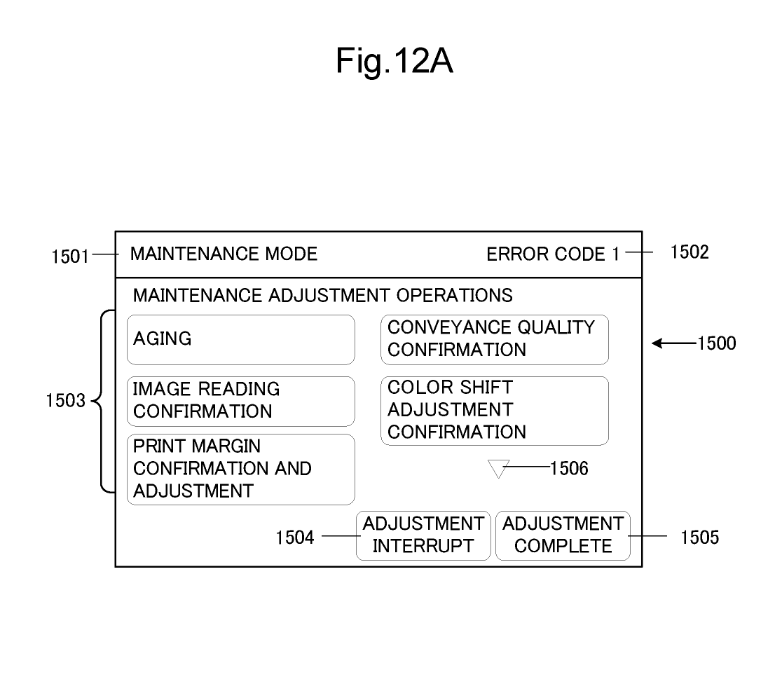

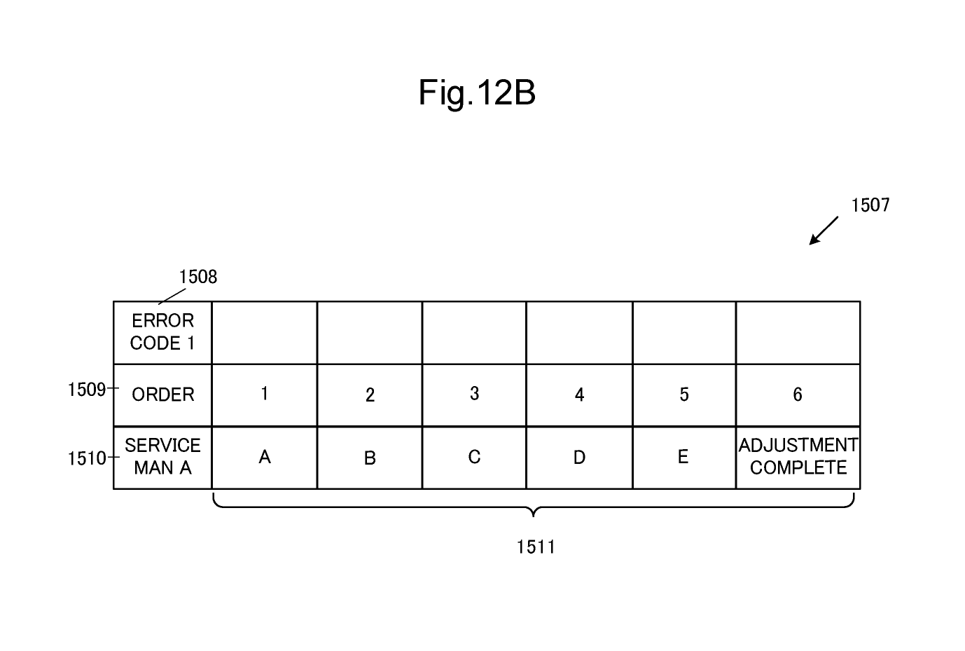

Displayed on the maintenance screen 1500 are: as shown in FIG. 12A, a message 1501 indicating the maintenance screen; the occurring specific error 1502 (“error code 1”); maintenance adjustment operation keys 1503 corresponding to the maintenance adjustment operations 1408; an adjustment interrupt key 1504 for interrupting the adjustment; and an adjustment complete key 1505 for completing the adjustment. Also displayed near the maintenance adjustment operation keys 1503 is a switch key 1506 for separately displaying a maintenance adjustment operation key that cannot be displayed on the maintenance screen 1500.

To resolve the specific error 1502, while viewing the maintenance screen 1500, the service man A selects the maintenance adjustment operation key 1503 to thereby receive the maintenance adjustment operation 1407 of the maintenance adjustment operation key 1503 and makes the image processor 1100 perform the processing corresponding to the maintenance adjustment operation 1407 (S1106 of FIG. 10).

For example, the service man A selects the “aging” key from among the maintenance adjustment operation keys 1503, upon which the maintenance control section 1203 executes processing corresponding to this “aging” key.

Here, in a case where the specific error is not resolved even by executing the processing described above, the service man A selects another maintenance adjustment operation key 1503 without selecting the adjustment complete key 1505 (NO in S1107 of FIG. 10) or without selecting the adjustment interrupt key 1504 (NO in S1108 of FIG. 10) and makes the image processor 1100 execute the processing corresponding to this key 1503 (S1106 of FIG. 10).

As described above, the service man A can resolve the specific error through repeated trials and errors on the various maintenance adjustment operations 1408. Here, for example, assume that the service man A selects the “aging” key, the “image reading confirmation” key, the “print margin confirmation and adjustment” key, the “conveyance quality confirmation” key, and the “color shift adjustment confirmation” key in an order just mentioned, and the maintenance control section 1203 sequentially executes the processing corresponding to the respective keys.

Then the specific error is resolved, and the sensor inside of the image processor 1100 no longer detects this specific error and the control section 1201 of the image processor 1100 notifies this to the maintenance control section 1203. The maintenance control section 1203 which has received this notice lights up the adjustment complete key 1505 on the maintenance screen 1500 and notifies the service man A that the adjustment has completed. Upon selection of the adjustment complete key 1505 by the service man A (YES in S1107 of FIG. 10), the maintenance adjustment operations corresponding to the specific error complete.

On the other hand, in a case where the specific error is not resolved even by selecting the various keys, the service man A may select the adjustment interrupt key 1504 (YES in S1108 of FIG. 10) without selecting the adjustment complete key 1505 (NO in S1107 of FIG. 10) to thereby forcibly interrupt the maintenance adjustment operations without resolving the specific error,

Here, upon the completion or interruption of the maintenance adjustment operations, the maintenance control section 1203 notifies this to an operation history section 1205, and the operation history section 1205 which has received this notice leaves, as a history, the plurality of maintenance adjustment operations executed by the service man for resolving the specific error (S1109 of FIG. 10).

For example, the operation history section 1205 acquires the plurality of maintenance adjustment operations (for example, the “aging”, the “image reading confirmation”, etc.) executed by the service man A for the specific error (“error code 1”) in an order in which the execution has taken place (for example, “1”, “2”, etc.). Next, the operation history section 1205, with reference to the maintenance adjustment operation table 1405, acquires the adjustment items (for example, “A”) corresponding to the acquired plurality of maintenance adjustment operations (for example, the “aging”) in the order described above. Then the operation history section 1205, based on the specific error, the adjustment item, and the order, creates a predetermined operation history table 1507, and stores this created operation history table 1507 into a third memory M13.

On the operation history table 1507, as shown in FIG. 12B, an error code 1508 (“error code 1”) corresponding to the specific error, an order 1509 (for example, “1”, “2”, etc.) in which the maintenance adjustment operations are executed, identification information 1510 of the service man (“service man A”) who has executed the maintenance adjustment operations, and adjustment items 1511 (for example, “A”, “B”, etc.) corresponding to the order 1509 are stored in association with each other. In a case where the last maintenance adjustment operation of the adjustment items 1511 has completed without any problem, “adjustment complete” indicating this is stored into the last order (“6”). As a result, the maintenance adjustment operations actually performed by each service man can be left as a history.

Upon completion of the aforementioned storage by the operation history section 1205, this is notified to an optimum operation extraction section 1206, and the optimum operation extraction section 1206 which has received this notice extracts the common maintenance adjustment operations executed for the specific error in common by the plurality of service men (S1110 of FIG. 10).

Here, at this point, the operation history table 1507 still has only the history of the maintenance adjustment operations performed by the single service man. Thus, in a case where only the history of maintenance adjustment operations performed by the single service man is present, the optimum operation extraction section 1206 also ends the extraction and subsequent creation of a flow of optimum maintenance adjustment operations (S1111 of FIG. 10).

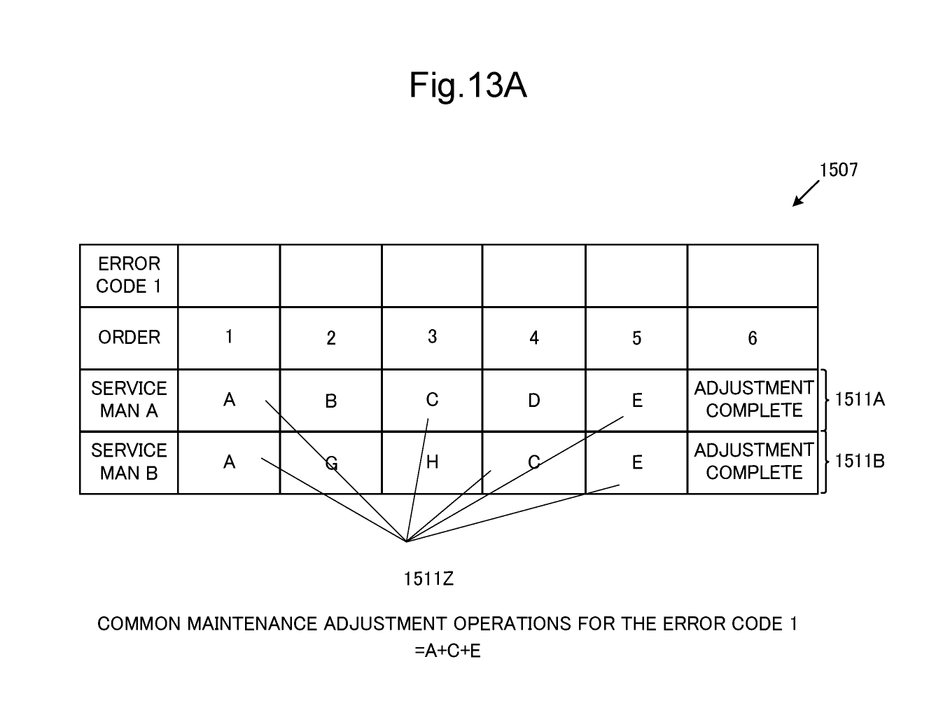

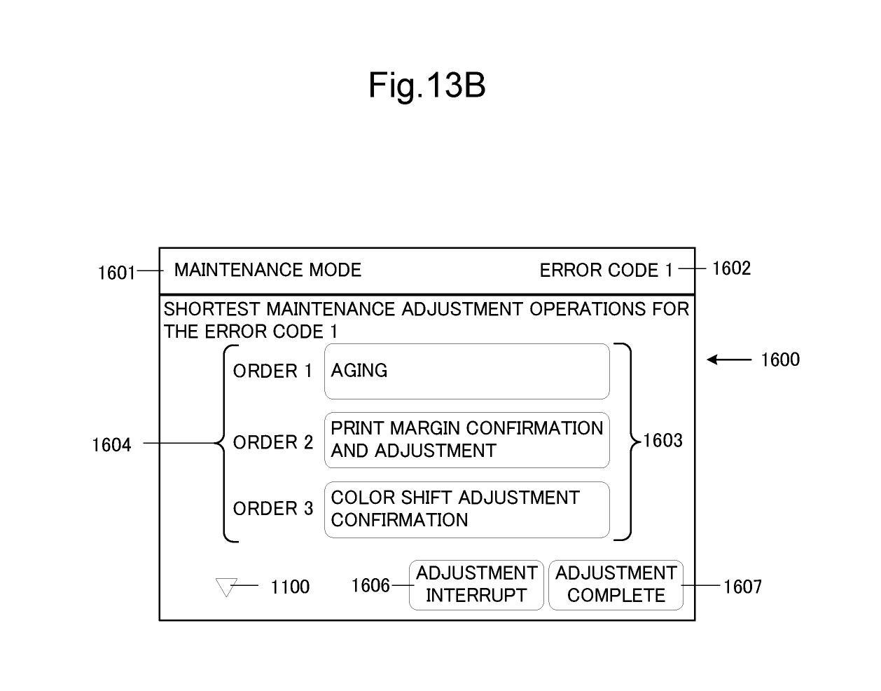

On the other hand, assume that the specific error occurs again, and this time the different service man (service man B) displays the maintenance screen 1500 and executes the plurality of maintenance adjustment operations to thereby resolve the specific error and end the maintenance adjustment operations. Then in S1109, the operation history section 1205 leaves, as a history, the plurality of maintenance adjustment operations executed by the service man B (S1109 of FIG. 10), and as shown in FIG. 13A, on the operation history table 1507, the plurality of maintenance adjustment operations executed by the two different service men are left as the histories. In this case, the optimum operation extraction section 1206, based on the operation history table 1507, extracts the common maintenance adjustment operations executed for the specific error in common by the plurality of service men (S1110 of FIG. 10).

More specifically, the optimum operation extraction section 1206 compares, on an individual adjustment item basis, a plurality of adjustment items 1511A belonging to one (service man A) of the service men and a plurality of adjustment items 1511B belonging to the other one (service man B) of the service men to extract common (identical) adjustment items 1511Z (“A”, “C”, and “E”). As described above, extracting only the common maintenance adjustment operations actually executed makes it possible to eliminate the operations assumed to be unnecessary and shorten adjustment time in the optimum maintenance adjustment operation.

Here, an order of the individual maintenance adjustment operations is important for resolution of the specific error in some cases. For example, in a case where the specific error is “blurred printing”, as the optimum maintenance adjustment operations, following the “aging”, the “print margin confirmation and adjustment” may be executed and then the “color shift adjustment confirmation” may be executed to thereby effectively resolve the “blurred printing”.

Thus, the optimum operation extraction section 1206 extracts the common maintenance adjustment operations, which have been executed in a common order by the plurality of service men, in this order. For example, as shown in FIG. 13A, in a case where an order of the common adjustment items 1511Z of one (service man A) of the service men is “A”, “C”, and “E” and an order of the common adjustment items 1511Z of the other one (service man B) of the service men is “A”, “C”, and “E”, the orders of the common adjustment items 1511Z are also common. In this case, the optimum operation extraction section 1206 extracts the common adjustment items 1511Z “A”, “C”, “E” in this order. This consequently permits extraction of the plurality of common maintenance adjustment operations which can reliably resolve the specific error.

On the other hand, for example, in a case where the order of the common adjustment items 1511Z of one (service man A) of the service men is “A”, C″, and “E” and the order of the common adjustment items 1511Z of the other one (service man B) of the service men is “A”, “E”, and “C”, the common adjustment items 1511Z of which orders are common are “A” and “C”. In this case, the optimum operation extraction section 1206 extracts the common adjustment items 1511Z “A” and “C” in this order. In other words, the common adjustment item 1511Z “E” is assumed not to have great contribution to the specific error resolution. As described above, any operation assumed to be unnecessary based on the order described above may be eliminated.

Upon completion of the extraction of the plurality of common maintenance adjustment operations (the common adjustment items 1511Z), a flow in which the plurality of common maintenance adjustment operations (common adjustment items 1511Z) are arranged in the order described above is created (S1111 of FIG. 10) and this flow is stored as the optimum maintenance adjustment operations into the first memory M1. This creates the optimum maintenance adjustment operations.

Then, if the specific error has occurred and the service man has made shifting to the maintenance mode again in S1103 (YES in S1103 of FIG. 10), the optimum operation display section 1204, with reference to the first memory M11, determines that the optimum maintenance adjustment operations for the specific error are present (YES in S1104 of FIG. 10). Then the optimum operation display section 1204, based on the optimum maintenance adjustment operations (flow) stored in the first memory M1, displays, on the touch panel of the operation section 1101, a maintenance screen 1600 with the optimum maintenance adjustment operations (S1112 of FIG. 10).

Displayed on the maintenance screen 1600 with the optimum maintenance adjustment operations are: as shown in FIG. 13B, a message 1601 indicating the maintenance screen; the occurring specific error 1602 (“error code 1”); maintenance adjustment operation keys 1603 corresponding to the optimum maintenance adjustment operations; an order 1604 of the optimum maintenance adjustment operations; a switch key 1605 for separately displaying a maintenance adjustment operation key; an adjustment interrupt key 1606; and an adjustment complete key 1607. This makes it possible for the service man to confirm the optimum maintenance adjustment operations, and execution of the optimum maintenance adjustment operations in accordance with the order 1604 makes it possible to easily resolve the specific error.

Conventionally, a service man has resolved the specific error by individually performing repeated the trial and error method. In particular, in a case where the service man comes over a site upon error occurrence and resolves the error of the image processor 1100, the error is resolved by returning to an optimum adjustment value in the maintenance adjustment operation or executing specific processing, but it is not ensured that each service man recognizes optimum operation procedures for this error and thus several maintenance adjustment operations are executed at the site, seeking for measures for resolution in a trial-and-error manner. The maintenance adjustment operations executed in the trial-and-error manner by each service man involves a great deal of unnecessary work.

In this disclosure, in order that the maintenance adjustment operations executed in the trial-and-error manner by each service man is not repeated, the unnecessary maintenance adjustment operations are eliminated, only the common maintenance adjustment operations are extracted, and the optimum maintenance adjustment operations are presented, whereby the repeated performance of the trial-and-error method by the service man can be eliminated, making it possible to achieve an efficient adjustment operation and then greatly shorten a period of time of the adjustment by the service man (working hours).

In this disclosure, the larger the number of service men executing the maintenance adjustment operations for the specific error is, the more the common maintenance adjustment operations are limited, making it possible to extract the efficient optimum maintenance adjustment operations.

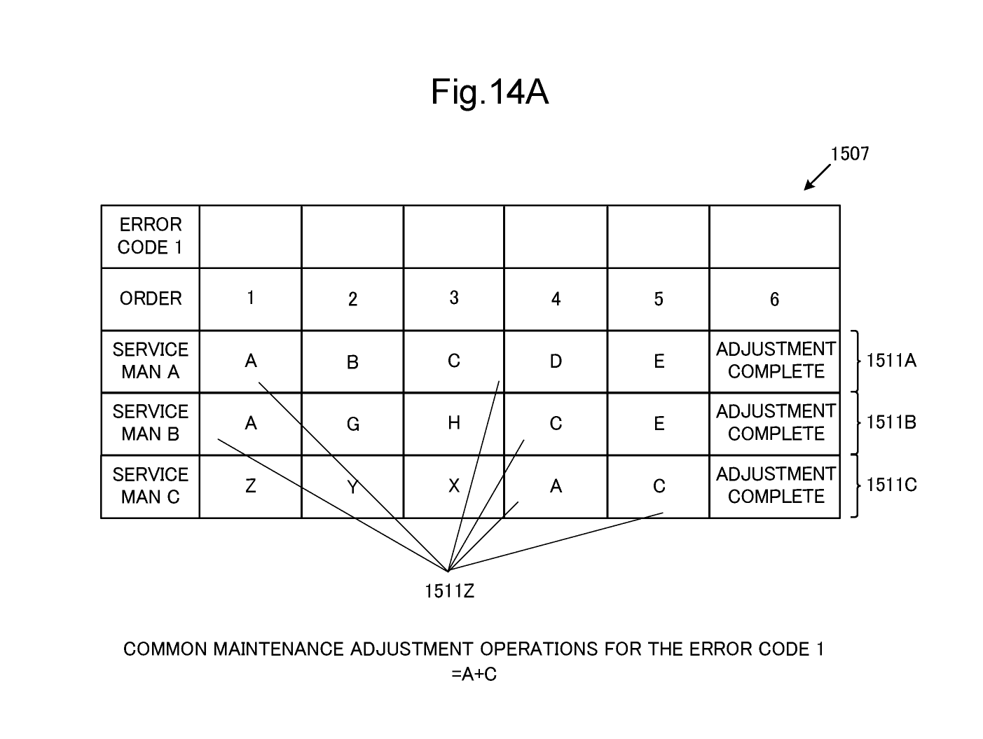

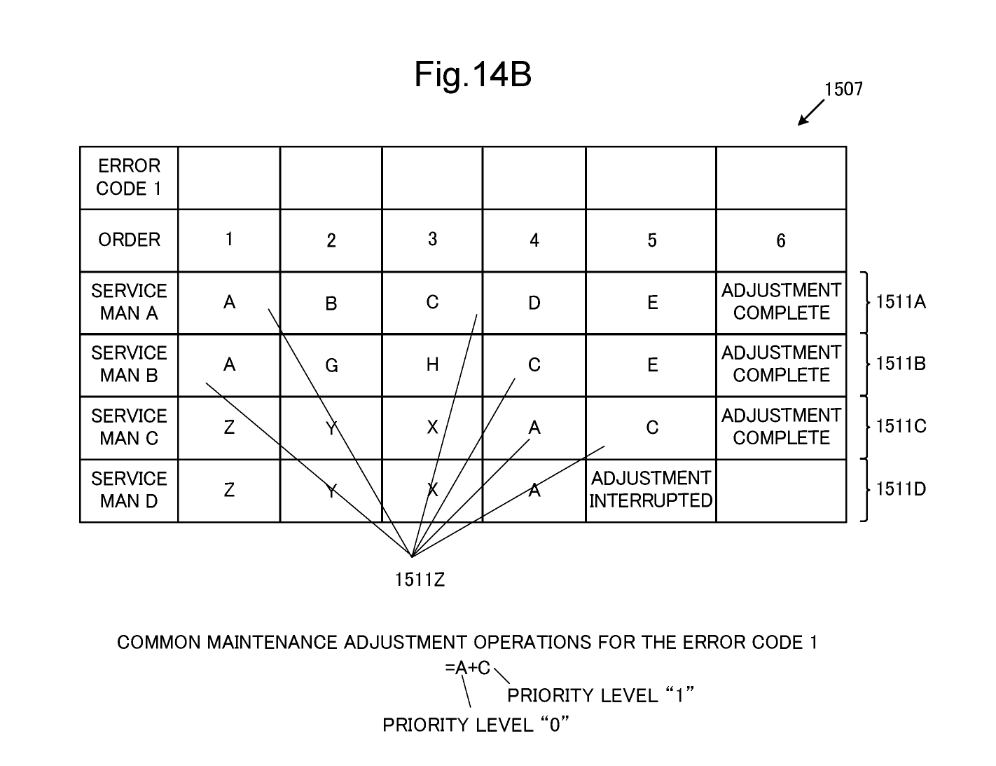

For example, as shown in FIG. 14A, in a case where the three service men executed maintenance adjustment operations for a specific error in the past, the optimum operation extraction section 1206, on the operation history table 1507, compares a plurality of adjustment items 1511A belonging to the first service man (service man A), a plurality of adjustment items 1511B belonging to the second service man (service man B), and a plurality of adjustment items 1511C belonging to the third service man (service man C) with each other on an individual adjustment item basis to extract the common (identical) adjustment items 1511Z (“A” and “C”). As described above, the larger the number of service men is, the more the common adjustment items 1511Z are limited, thus making it possible to extract the efficient optimum maintenance adjustment operations.

In the above, the completed maintenance adjustment operations completed by the service man when the specific error has been resolved are targeted, but different configuration may be provided. For example, the operation history section 1205 may leave, as a history, in addition to the completed maintenance adjustment operations, the interrupted maintenance adjustment operations interrupted by the service man when the specific error has not been resolved. Then the optimum operation extraction section 1206, based on the completed maintenance adjustment operations, extract the common maintenance adjustment operations, and extracts, as the preferential common maintenance adjustment operations, the common maintenance adjustment operations not included in the interrupted maintenance adjustment operations.

For example, in a case where the three service men have completed the maintenance adjustment operations for the specific error and one of the service men has interrupted the maintenance adjustment operations for the specific error, as shown in FIG. 14B, the optimum operation extraction section 1206, on the operation history table 1507, targeting on the completed maintenance adjustment operations (the adjustment items 1511A, 1511B, and 1511C) of the three service men, compares the plurality adjustment items 1511A belonging to the first service man (service man A), the plurality of adjustment items 1511B belonging to the second service man (service man B), and the plurality of adjustment items 1511C belonging to the third service man (service man C) with each other on an individual adjustment item basis to extract the common adjustment items 1511Z (“A” and “C”). Next, the optimum operation extraction section 1206, targeting on the interrupted maintenance adjustment operations (adjustment items 1511D) of one of the service men, compares a plurality of adjustment items 1511D belonging to a fourth service man (service man D) and the common adjustment items 1511Z with each other on an individual adjustment item basis, and searches for any common adjustment item 1511Z not present in the adjustment items 1511D. In FIG. 14B, the plurality of adjustment items 1511D belonging to the fourth service man do not include “C” as the common adjustment item 1511Z, and thus the optimum operation extraction section 1206 extracts the absent “C” of the common adjustment item 1511Z as the preferential common adjustment item. This “C” of the common adjustment item 1511Z is assumed to be an essential adjustment item for resolving the specific error, and thus for example, the optimum operation extraction section 1206 provides the searched “C” of the common adjustment item 151z with a high priority level “1” and provides the non-searched “A” of the common adjustment item 1511Z with a low priority level “0”. Then the optimum operation display section 1204, upon display of the optimum maintenance adjustment operations, performs this display in a manner such as to make the service man preferentially execute the optimum maintenance adjustment operation “C” of the common adjustment items 1511Z which is included in the optimum maintenance adjustment operations and which is provided with the high priority level. For example, the maintenance adjustment operation “C” of the common adjustment items 1511Z provided with the high priority level is displayed at an upper position and the maintenance adjustment operation “A” of the common adjustment items 1511Z provided with the low priority level is displayed at a lower position. This makes it possible for the service man to execute the even more efficient optimum maintenance adjustment operations.

Typically, an electronic device such as an image processor, in view of quality control of provided functions, requires execution of regular maintenance. For example, there is a printer which manages a printer history and which provides an alarm prompting an operator to perform maintenance based on this history information. Also known is an image forming apparatus which, upon performance of maintenance requiring confirmation of a plurality of maintenance items in the image forming apparatus, avoids inconvenience such that the screen is switched many times.

However, as described above, in such a printer and an image forming apparatus, repeatedly performing the maintenance adjustment operations for an error (trouble) of, for example, the electronic device in a trial-and-error manner by the service man requires finding of procedures of the optimum maintenance adjustment operation capable of resolving the error, which raises a problem such that it takes much time and labor.

According to another embodiment of this disclosure described above, it is possible to present an optimum maintenance adjustment operation based on a history of past maintenance adjustment operations.

In another embodiment of this disclosure described above, it is configured such that the optimum operation extraction section 1206 extracts the common maintenance adjustment operations, which have been executed in a common order by the plurality of service men, in the order just mentioned, but different configuration may be provided. As described above, an order of the individual maintenance adjustment operations is important for the specific error resolution in some cases, but executing the common maintenance adjustment operations in a random order resolves the specific error in some cases. In such a case, the optimum operation extraction section 1206 may display the common maintenance adjustment operations as the optimum maintenance adjustment operations without considering the order.

In another embodiment of this disclosure described above, the optimum operation display section 1204 displays the plurality of common maintenance adjustment operations as the optimum maintenance adjustment operations on one maintenance screen 1600, but a display mode is not specifically limited. Of the optimum maintenance adjustment operations, the individual common maintenance adjustment operations may be displayed through operation by the service man in correspondence with the order (flow procedures).

Moreover, in another embodiment of this disclosure described above, the image processor 1100 provided with the maintenance management section 1105 has been described, but this disclosure is also applicable to an electronic device, which upon error occurrence, requires resolution of this error by a service man.

Described in another embodiment described above is that the image processor 1100 includes the aforementioned various sections (at least the optimum operation display section 1204, the operation history section 1205, and the optimum operation extraction section 1206), but a program realizing the aforementioned various sections (at least the optimum operation display section 1204, the operation history section 1205, and the optimum operation extraction section 1206) of the image processor 1100 may be stored in a recording medium such as the HDD or the memory of the image processor 1100 and the CPU of the image processor 1100 may operate in accordance with this program to thereby function as the aforementioned various sections (at least the optimum operation display section 1204, the operation history section 1205, and the optimum operation extraction section 1206).

In this case, the program itself read from the recording medium provides effects as the embodiments of this disclosure.

Moreover, the procedures of the processing performed by the image processor 1100, which have been shown in another embodiment described above, are also recognized as an image processing method performed by the image processor.

Various modifications and alterations of this disclosure will be apparent to those skilled in the art without departing from the scope and spirit of this disclosure, and it should be understood that this disclosure is not limited to the illustrative embodiments set forth herein.

### INDUSTRIAL APPLICABILITY

As described above, the maintenance management device and the maintenance management method according to this disclosure are useful for electronic devices including an image forming apparatus such as a multifunction peripheral, a copier, a printer, or a scanner, and are effective as a maintenance management device and a maintenance management method capable of reducing loads on a user and a service man for specific error resolution.

What is claimed is:

1. A maintenance management device comprising:
an operation history section, upon execution of a plurality of maintenance adjustment operations by a service man, leaving the plurality of maintenance adjustment operations as a history for the purpose of resolving a specific error, and
an optimum operation extraction section, based on the history, extracting, as an optimum maintenance adjustment operation, a common maintenance adjustment operation executed for the specific error in common by the plurality of service men.

2. The maintenance management device according to claim 1, further comprising
a processing reception and execution section, upon occurrence of the specific error, receiving, from a user, execution of processing corresponding to the optimum maintenance adjustment operation, and executing the processing.

3. The maintenance management device according to claim 2,
wherein the optimum operation extraction section, based on the history, extracts, as the optimum maintenance adjustment operations, the plurality of common maintenance adjustment operations, which have been executed in a common order by the plurality of service men, in correspondence with the common order.

4. The maintenance management device according to claim 2,
wherein, in a case where a number of the common maintenance adjustment operations forming the optimum maintenance adjustment operations exceeds a predefined threshold value, the processing reception and execution section receives the execution of the processing corresponding to the optimum maintenance adjustment operation from only a manager authorized as a manager, and
in a case where the number of the common maintenance adjustment operations forming the optimum maintenance adjustment operations is equal to or smaller than the threshold value, the processing reception and execution section receives the execution of the processing corresponding to the optimum maintenance adjustment operation from all users including the manager.

5. The maintenance management device according to claim 1,
further comprising an optimum operation display section, upon occurrence of the specific error, displaying the extracted common maintenance adjustment operation as the optimum maintenance adjustment operation.

6. The maintenance management device according to claim 5,
wherein the optimum operation extraction section, based on the history, extracts the common maintenance adjustment operations, which have been executed in a common order by the plurality of service men, in the common order just mentioned, and
the optimum operation display section displays the extracted common maintenance adjustment operation as the optimum maintenance adjustment operation in correspondence with the order.

7. The maintenance management device according to claim 5,
wherein the operation history section leaves, as a history, completed maintenance adjustment operations completed by the service man when the specific error has been resolved and interrupted maintenance adjustment operations interrupted by the service man when the specific error has not been resolved,
the optimum operation extraction section preferentially extracts, as the optimum common maintenance adjustment operation, from among the completed maintenance adjustment operations, the common maintenance adjustment operation not included in the interrupted maintenance adjustment operations, and
the optimum operation display section preferentially displays the preferentially extracted optimum common maintenance adjustment operation.

8. A maintenance management method comprising:
an operation history step of, upon execution of a plurality of maintenance adjustment operations by a service man, leaving the plurality of maintenance adjustment operations as a history for the purpose of resolving a specific error; and
an optimum operation extraction step of, based on the history, extracting, as an optimum maintenance adjustment operation, the common maintenance adjustment operation executed for the specific error in common by a plurality of service men.

9. The maintenance management method according to claim 8,
further comprising a processing reception and execution step of, upon occurrence of the specific error, receiving, from a user, execution of processing corresponding to the optimum maintenance adjustment operation and executing the processing.

10. The maintenance management method according to claim 8,
further comprising an optimum operation display step of, upon occurrence of the specific error, displaying the extracted common maintenance adjustment operation as the optimum maintenance adjustment operation.
